(19) United States
(12) Patent Application Publication
(10) Pub. No.: US 2020/0012944 A1
(43) Pub. Date: Jan. 9, 2020

(54) METHOD AND SYSTEM FOR DETECTING SWITCH DEGRADATION AND FAILURES

(71) Applicants: ALSTOM TRANSPORT TECHNOLOGIES, Saint-Ouen (FR); FLORIDA INSTITUTE OF TECHNOLOGY, Melbourne, FL (US)

(72) Inventors: Nenad MIJATOVIC, Melbourne, FL (US); Adrian Manoj PETER, Rockledge, FL (US); Mitchell SOLOMON, Melbourne, FL (US); Kailas V. RAJAN, Gainesville, FL (US); Emily JENSEN, TEMPE, AZ (US)

(73) Assignees: ALSTOM TRANSPORT TECHNOLOGIES, Saint-Ouen (FR); FLORIDA INSTITUTE OF TECHNOLOGY, Melbourne, FL (US)

(21) Appl. No.: 16/027,658

(22) Filed: Jul. 5, 2018

(51) Int. Cl. G06N 3/08; B61L 23/04

(52) U.S. Cl. CPC G06N 3/082; B61L 23/041; B61L 23/047; G06N 3/084; B61L 23/045

(57) ABSTRACT

Method for detecting switch degradation and failures having steps of collecting and labelling, into predefined categories, switch machine data relative to a predetermined controlled switch placed in supervised environment and conditions; storing the labeled data of each movement switch in a database and pre-processing the labelled data. A learning LSTM weights and cell parameters by performing a training phase on a LSTM network using the pre-processed data, thus obtaining a final LSTM model inclusive of architecture and parameters of the LSTM network suitable for analyzing switch data relative to movements of switches actually located on a railway track; collecting data relative to the movements of a switch located on a railway track; and classifying the switch movements into said categories by applying the collected data to the final LSTM, thus detecting switch degradations and failures.

### FEDERALLY SPONSORED RESEARCH

This invention was made with government support under 1263011 and 1560345 awarded by the National Science Foundation. The government has certain rights in the invention.

### FIELD OF TECHNOLOGY

The present invention relates to a method and a system for detecting switch degradation and failures.

### BACKGROUND

It is known that rail switches are critical infrastructure components of a railway network, therefore, it is important that they maintain a high-level of reliability during operation.

Up to now, the correct functioning of the railway switches has been determined by monitoring basic switch parameters, but these parameters only provide information about the healthy or non-healthy status of the switches. These parameters cannot be used to distinguish between different types of degradations such as loss of lubrication, obstacles, loose screws, etc.

In addition, there are several types of switches that can be employed in railway networks, therefore, the analysis is usually done based on the type of switch.

### SUMMARY

There is therefore the need to have an automated method and system for detecting switch degradations and failures which is robust, easy to apply and which can be adapted to any type of switch.

This and other objectives are achieved by a system and method for detecting switch degradations and failures having the characteristics defined below.

Preferred embodiments of the invention are the subject matter of the dependent claims, whose content is to be understood as forming an integral part of the present description.

### BRIEF DESCRIPTION OF THE DRAWINGS

Further characteristics and advantages of the present invention will become apparent from the following description, provided by way of non-limiting examples, with reference to the enclosed drawings, in which:

FIG. 1 shows an example of a block diagram of the LSTM network; and

FIG. 2 shows a block scheme of the system for detecting switch degradations and failures according to the present invention.

### DETAILED DESCRIPTION

Briefly, the method for detecting switch degradations and failures according to the present invention classifies various switch degradation levels by using a deep neural network that does not require any manual feature extraction governed by a field expert. A known featureless recurrent neural network called a Long Short Term Memory (LSTM) is able to capture the dynamical and discriminative characteristics of measurements associated with any switch transitions. To achieve reliability and meet safety requirements, the LSTM network is trained on a data set representative of the movements/maneuvers of a controlled switch which are known, so as to determine the actual parameters of the LSTM network and then use the so-trained LSTM network on switches actually located on a railway track to detect anomalies.

The method according to the present invention starts at an initial step wherein, during each switch maneuver of a controlled switch, various data such as current and voltage signals are measured using a sensor placed in proximity of the controlled switch, for example a data acquisition unit (DAU). The data are then uniformly sampled and ordered in the form of a time series data set, and finally supplied to a LSTM network for its training.

The LSTM network, being a special kind of Recursive Neural Network (RNN), is capable of learning long-term dependences from the data input set. As such, the LSTM network reveals and distinguishes a normal signal behavior from defective ones. As a conventional neural network, the LSTM network architecture consists of input, hidden, and output layers. All of the layers are interconnected with weighted connections. Similar to RNN, the inputs are passed through hidden states of the same level as well. To avoid vanishing and exploding gradient problems, LSTM nodes are implemented as sophisticated cells that impose a set of functions to regulate data passage through the network; these rules include memory and gate functions (input, remember/forget, and output).

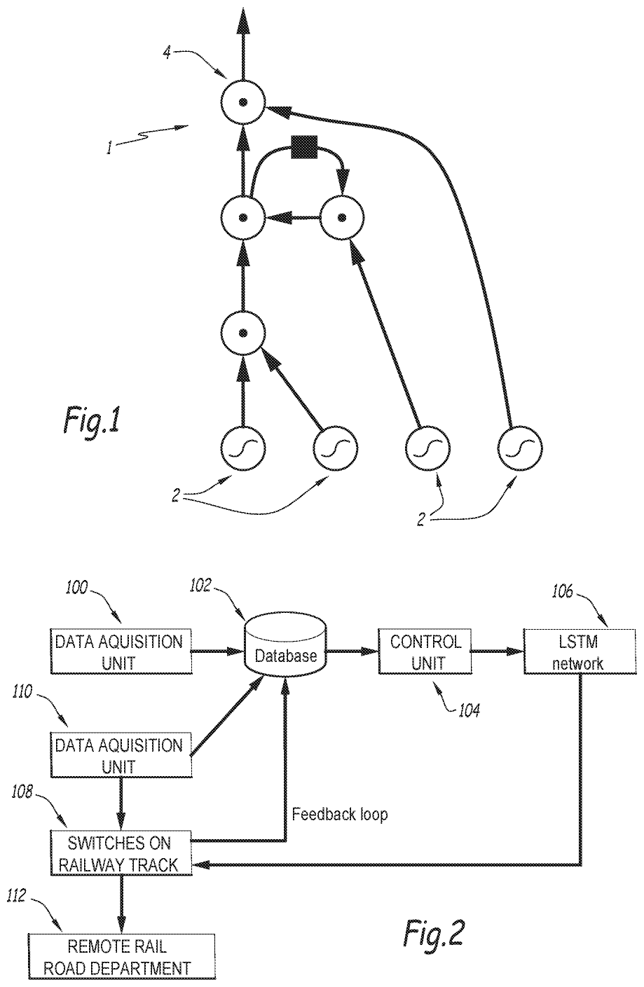

FIG. 1 shows an example of a block diagram of the LSTM network 1 including a plurality of input nodes 2 and an output node 4.

The number of LSTM input nodes 2 is equal to the number of samples for each switch machine movement/maneuver, while the number of LSTM output nodes 4 is equal to the desired number of classes (both healthy and unhealthy). The number of hidden layers, as well as the number of cells within the layers, is learned during a testing stage. In order to perform a switch signal classification, an optimal set of forward weights, including hidden cell parameters, is determined during a training phase on a labeled data set, in order to reduce the misclassification error. During the training phase, the labeled time series signals are forwarded from the input nodes 2, through hidden layers, to the output nodes 4, and then the appropriate loss and classification probabilities are calculated at each output node 4. LSTM weights and parameters are optimized using the back-propagation optimization technique called “Adam”. To avoid overfitting, dropout regularization is performed as well. Once the optimized set of LSTM parameters is determined, the testing stage is performed to estimate the classification accuracy.

FIG. 2 shows a block scheme of the system used for performing the method for detecting switch degradations and failures using the LSTM network according to the present invention.

In a first step 100, switch machine data relative to movements/maneuvers of a controlled switch, placed in a supervised environment and conditions, are collected and labelled into a plurality of predefined categories representative of the status of the controlled switch, i.e. healthy, degraded type 1, degraded type 2, etc., using a switch data acquisition unit (DAU) or any other suitable sensor. Therefore, in step 100, current and/or voltage signals associated with switch maneuvers of a controlled switch are acquired through a DAU associated with the controlled switch, and uniformly sampled and ordered as a time series data set, and then labelled into predetermined categories, by a control unit associated with the sensors. This controlled switch is a switch whose maneuvers are known a priori, and this step 100 is useful for collecting and classifying data to use to train a LSTM network, so as to subsequently apply the trained LSTM model to switches actually located on the railway track to classify their movements in order to detect degradations and failures.

The labelled data are then stored, in a step 102, in a database. Each switch maneuver of the controlled switch is therefore stored with its associated original data, presented as time series, as well as with an appropriate label representative of a condition of the switch.

Subsequently, in a step 104, the labelled data are pre-processed by a control unit connected to the database by removing from each sample the mean and by normalizing (dividing) each sample by the standard deviation of the labelled data for each time series related with one switch move. Advantageously, other feature extraction methods might be used as well, such as calculation of the mean, calculation of the standard deviation, calculation of function expansion, etc.

In a next step 106, LSTM weights and cell parameters are learned by performing in a known manner a training phase on a LSTM network by using the pre-processed data. Based on this training phase, states of the LSTM are “learned” based on features automatically extracted from the pre-processed data. It is important to note that the time series data are unique for each switch machine because of the imperfect manufacturing process of the switch itself which introduces various uncontrollable errors in the generated time series data. Hence, in order to achieve optimal classification accuracies, the LSTM network is trained, in step 106, to the predetermined pre-processed data corresponding to known movements and associated categories, so as to determine the architecture specification of the LSTM network itself. The result of this training phase is a final LSTM model inclusive of architecture and parameters of the LSTM network suitable for analyzing switch data relative to switches actually located on a railway track.

After having trained the LSTM network on the pre-processed data set, in step 108 the final LSTM model, which comprises, as noted above, optimal network architecture and parameters, is deployed on different switches located on a railway track in order to classify any new movement/maneuver of said switches into the predefined categories disclosed above. In particular, all data from the switches located on the railway track are collected, in step 110, using a data acquisition unit or edge sensor associated with the switch, and then sent to a switch processing unit which performs the classification of the switch movements by using the final LSTM model (step 108). Advantageously, in step 110 the data acquisition unit performs a global pre-processed step on the collected data similar to the one described in step 104.

If the switch processing unit identifies a degraded state of the switch, because the data relative to a switch movement corresponds to a category representative of a degradation or a failure of the switch itself, in step 112 an alarm is sent to a remote rail road signaling department and, based on the degradation type identified, the appropriate maintenance intervention is performed.

In case of faulty classification, all appropriate switch machine data can be sent back to the development stage through the feedback loop in order to readjust the LSTM parameters.

Clearly, the principle of the invention remaining the same, the embodiments and the details of production can be varied considerably from what has been described and illustrated purely by way of a non-limiting example, without departing from the scope of protection of the present invention as defined by the attached claims.

1. Method for detecting switch degradation and failures comprising the steps of:
collecting and labelling, into predefined categories, switch machine data relative to a predetermined controlled switch placed in supervised environment and conditions;
storing the labeled data of each movement switch in a database;
pre-processing the labelled data;
learning LSTM weights and cell parameters by performing a training phase on a LSTM network using the pre-processed data, thus obtaining a final LSTM model inclusive of architecture and parameters of the LSTM network suitable for analyzing switch data relative to movements of switches actually located on a railway track;
collecting data relative to the movements of a switch located on a railway track; and
classifying the switch movements into said categories by applying the collected data to the final LSTM, thus detecting switch degradations and failures.

2. The method of claim 1, wherein the step of pre-processing the labelled data comprises removing, from said labelled data, the overall mean and normalizing by the overall standard deviation of the labelled data.

3. The method of claim 1, wherein the step of collecting and labelling switch measurement data includes measuring current and/or voltage signals associated with switch maneuvers of the controlled switch and sampling these signals.

4. The method of claim 1, wherein the step of pre-processing the labelled data includes applying predetermined feature extraction methods.

5. The method of claim 4, wherein the feature extractions methods include calculation of the mean, calculation of standard deviation, calculation of function expansion.

6. The method of claim 1, further comprising the step of sending an alarm if a degraded state of the switch is identified, said degraded state corresponding to data relative to a switch movement belonging to a category representative of a degradation or a failure.

7. A system for detecting switch degradation and failures comprising:
sensors placed in proximity of a controlled switch arranged to measure switch machine data relative to movements of the controlled switch;
a control unit, connected to said sensors, arranged to label said switch machine data into predetermined categories;
a database arranged to store the labelled data;
a control unit, connected to said database, arranged to pre-process the labelled data;
a LSTM network arranged to perform a training phase by using said pre-processed labelled data, so as to obtain a final LSTM model suitable for classifying switch data relative to switch movements of switches actually located on a railway track into said categories, thus detecting switch degradation and failures.

8. A system according to claim 7, wherein the control unit arranged to pre-process the labelled data removes, from said labelled data, the overall mean and normalizes by the overall standard deviation of the labelled data.
